(19) United States
(12) Patent Application Publication
(10) Pub. No.: US 2026/0145192 A1
(43) Pub. Date: May 28, 2026

(54) ACCUMULATOR SPRAYER

(71) Applicant: CANYON CORPORATION, Tokyo (JP)

(72) Inventors: Naoko SATOH, Tokyo (JP); David RANGEL, Newtownabbey (GB); Mitsuaki SHAZUKI, Sanyo Onoda-shi, Yamaguchi (JP)

(21) Appl. No.: 18/861,298

(22) PCT Filed: Apr. 25, 2023
(86) PCT No.: PCT/JP2023/016205

§ 371 Date: Oct. 29, 2024

(30) Foreign Application Priority Data
Apr. 29, 2022 (JP) 2022-075600

(51) Int. Cl. B05B 11/10

(52) U.S. Cl. CPC B05B 11/104; B05B 11/1057

(57) ABSTRACT

An accumulator sprayer comprises parts made of polyolefin material including: nozzle portion F; base portion B containing first passage portion P1 having sub-cylinder portion B2 and main cylinder portion B1 located below, and connecting a container to the main cylinder portion, second passage portion P2 connecting the main cylinder portion to the sub-cylinder portion, and third passage portion P3 connecting the sub-cylinder portion to the nozzle portion; a piston portion sliding within the main cylinder portion; trigger portion E pivoting around support shaft portion BA, formed protrusively on a side surface of the base portion; first valve FV provided in the first passage portion; second valve structure A mounted in the sub-cylinder portion; introduction tube H suctioning up and passing through the liquid from the container; cover portion C; cap portion G for attaching to the container; and a packing for sealing the cap portion and the base portion.

### TECHNICAL FIELD

The present invention relates to an accumulator sprayer that is recyclable and can be converted into resources efficiently, thereby ultimately contributes to the Sustainable Development Goals (SDGs).

### BACKGROUND ART

As a liquid-ejecting spray, there is a so-called accumulator sprayer including a special second valve for enhancing an ejection force.

In general, this accumulator spray is configured to, when a piston is slid with respect to a cylinder to apply pressure to liquid, instantaneously eject, from a nozzle, the liquid in the cylinder in a state in which its pressure exceeds a certain pressure.

It can eject the liquid at a dash when it comes into the certain pressure, which is quite useful.

As for such accumulator sprayer, various developments have conventionally been made with respect to the components constituting them.

For example, disclosed in PTL 1 is an accumulator trigger sprayer which, in a state of being attached to a container, moves a piston portion with rotation of a trigger portion, applies pressure to liquid inside a cylinder portion of the cylinder portion and, when the pressure becomes a certain pressure, ejects the liquid via a passage P from a nozzle portion.

In this trigger sprayer, a coil spring is used to apply elastic force to a second valve, and for this coil spring, a metal coil spring is employed to ensure sufficient elastic force.

### CITATION LIST

### Patent Literature

PTL 1: Japanese Patent Application Laid-Open No. 2017-13008

### SUMMARY OF INVENTION

### Technical Problem

However, in the above-described accumulator trigger sprayer, the metallic components are less likely to integrate smoothly into the recycling process.

In particular, although the accumulator trigger sprayer is handheld and compact, many of its parts are formed from synthetic resin materials, so when metallic parts are included, they must be sorted and removed.

Therefore, from the viewpoint of material recyclability, it is extremely inefficient and cannot be considered preferable.

Today, in line with the trend of SDGs, there is a growing demand for recycling and resource efficiency, and the accumulator trigger sprayer with recyclability is strongly sought after.

Furthermore, from the viewpoint of resource efficiency, there is also a demand for the accumulator trigger sprayer with minimized number of parts.

The present invention was made with the above-described circumstances as a background, and thus, an object of the present invention is to provide an accumulator sprayer that facilitates material recycling and further provides the accumulator sprayer that enhances resource efficiency, thereby contributing to the achievement of the SDGs.

### Solution to Problems

The present inventors have conducted extensive research to solve the above problems and have come up with the idea that, in the second valve, by integrating the spring portion and the valve portion and injection-molding them using a specific synthetic resin, it is possible to eliminate metal components while simultaneously reducing the number of parts, thereby enabling it to be recycled as a material.

The present invention has been completed based on this finding.

That is, the present invention resides in (1) an accumulator sprayer X comprising parts made of polyolefin material, wherein the parts include: a nozzle portion F; a base portion B containing a first passage portion P1 having a sub-cylinder portion B2 located above and a main cylinder portion B1 located below, and connecting a container to the main cylinder portion B1, a second passage portion P2 connecting the main cylinder portion B1 to the sub-cylinder portion B2, and a third passage portion P3 connecting the sub-cylinder portion B2 to the nozzle portion; a piston portion that slides within the main cylinder portion B1; a trigger portion E that pivots around a support shaft portion BA, formed protrusively on a side surface of the base portion B, as a fulcrum and slides the piston portion rearward; a trigger-returning spring I that returns the trigger portion E forward; a first valve FV provided in the first passage portion P1; a second valve structure A mounted in the sub-cylinder portion B2; an introduction tube H that suctions up and passes through the liquid from the container; a cover portion C that covers the base portion B from above; a cap portion G for attaching to the container; and a packing K for sealing the cap portion and the base portion B.

The present invention also resides in the accumulator sprayer X described in Claim 1, wherein (2) the second valve structure A comprises a spring portion 1 and a valve piston portion 2, and the spring portion 1 and the valve piston portion 2 are integrally molded.

The present invention also resides in the accumulator sprayer X, wherein (3) the second valve structure A is in an unloaded state, not subjected to compressive force in a vertical direction, in an initial set state when incorporated into the accumulator sprayer X.

The present invention also resides in the accumulator sprayer X (high performance, low friction, energy efficiency), wherein (4) a support shaft portion BA formed on the base portion has a cross-sectional shape including a large arc portion BA1 and a small arc portion BA2, with a defect portion formed between them.

The present invention also resides in the accumulator sprayer X, wherein (5) let a distance between a bottom B2A of the sub-cylinder portion B2 and a support wall portion C1 of the cover portion C be denoted as L2, and let a vertical length of the second valve structure A in an unloaded state (i.e., not incorporated) be denoted as L1, the relationship between them becomes L2>L1.

The present invention also resides in the accumulator sprayer X, wherein (6) the trigger portion and the trigger-returning spring are formed integrally (as a single body) by injection molding during manufacturing.

### Advantageous Effects of Invention

The present invention is extremely useful as (1) it includes all components of the accumulator sprayer X since it comprises parts made of polyolefin material, wherein the parts include: a nozzle portion F; a base portion B containing a first passage portion P1 having a sub-cylinder portion B2 located above and a main cylinder portion B1 located below, and connecting a container to the main cylinder portion B1, a second passage portion P2 connecting the main cylinder portion B1 to the sub-cylinder portion B2, and a third passage portion P3 connecting the sub-cylinder portion B2 to the nozzle portion; a piston portion that slides within the main cylinder portion B1; a trigger portion E that pivots around a support shaft portion BA, formed protrusively on a side surface of the base portion B, as a fulcrum and slides the piston portion rearward; a trigger-returning spring I that returns the trigger portion E forward; a first valve FV provided in the first passage portion P1; a second valve structure A mounted in the sub-cylinder portion; an introduction tube H that suctions up and passes through the liquid from the container; a cover portion C that covers the base portion B from above; a cap portion G for attaching to the container; and a packing K for sealing the cap portion and the base portion B, therefore their materials are easily recyclable, thereby contributing to resource efficiency and ultimately to the achievement of SDGs.

Also, since (2) the second valve structure A comprises a spring portion 1 and a valve piston portion 2, and the spring portion 1 and the valve piston portion 2 are integrally molded, the number of parts can be reduced, and both the spring function and the valve function can be exhibited in a smaller spatial region.

Therefore, the second valve structure A can be positioned as far upward as possible, thereby the available installation area of the main cylinder toward the rear side can be extended.

As a result, the rearward travel distance of the piston portion can be increased, allowing for a larger discharge volume (spray volume) while reducing the pulling force of the trigger portion, that is, minimizing mechanical load.

Also, since (3) the second valve structure A is in an unloaded state, not subjected to compressive force in a vertical direction, in an initial set state when incorporated into the accumulator sprayer X, no plastic deformation occurs in polyolefin as the material of the spring portion, and the valve function is always performed efficiently.

Also, since (4) a support shaft portion BA formed on the base portion has a cross-sectional shape including a large arc portion BA1 and a small arc portion BA2, with a defect portion formed between them, a small space S is created between a bearing hole portion E1 of the trigger portion and the support shaft portion BA, and the frictional force is reduced compared to the conventional art.

Also, since (5) let a distance between a bottom B2A of the sub-cylinder portion B2 and a support wall portion C1 of the cover portion C be denoted as L2, and let a vertical length of the second valve structure A in an unloaded state (i.e., not incorporated) be denoted as L1, the relationship between them becomes L2>L1, no plastic deformation occurs in the material.

As a result, the function of the spring portion of the second valve structure A is always maintained.

Also, since (6) the trigger portion and the trigger-returning spring are formed integrally (as a single body) by injection molding during manufacturing, although they become separate components and function separately after assembly, they can be manufactured simultaneously as a single unit, manufacturing costs can be significantly reduced.

### BRIEF DESCRIPTION OF DRAWING

FIG. 1 is a perspective view showing an accumulator sprayer of the present invention.

FIG. 2 is a side view showing the accumulator sprayer of the present invention.

FIG. 3 is a longitudinal sectional view showing the accumulator sprayer of the present invention.

FIG. 4 is a longitudinal sectional view showing an arrangement state of a second valve structure in the accumulator sprayer of the present invention, illustrating an unloaded state in an initial set state.

FIG. 5 is a longitudinal sectional view showing the accumulator sprayer of the present invention, illustrating a state where the second valve structure has reached a top dead center.

FIG. 6 is a longitudinal sectional view showing an arrangement state of the second valve structure in the accumulator sprayer of the present invention, illustrating a state where the second valve structure has reached the top dead center.

FIG. 7 is a diagram illustrating the relationship between a trigger portion and a support shaft portion.

### DESCRIPTION OF EMBODIMENTS

In the following, with reference to the drawings as required, a preferred embodiment of the present invention is described in detail.

Note in the drawings that the same components are provided with the same reference numeral and redundant description is omitted.

Also, relations in position such as above, below, left, and right are assumed to be based on the position relation depicted in the drawings unless otherwise specified.

Furthermore, the dimensional ratios of the drawings are not limited to the ratios depicted in the drawings.

### Embodiment

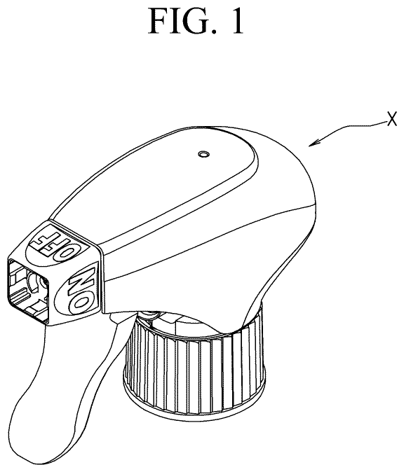

FIG. 1 is a perspective view showing an accumulator sprayer X of the present invention.

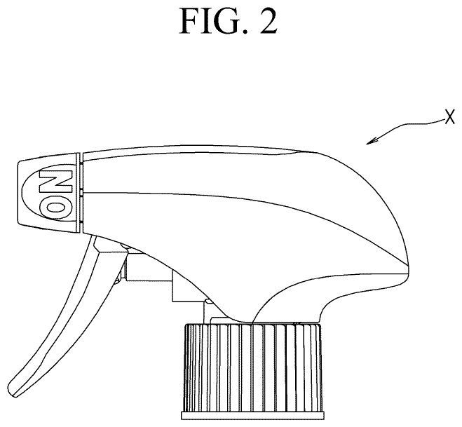

FIG. 2 is a side view showing the accumulator sprayer X of the present invention.

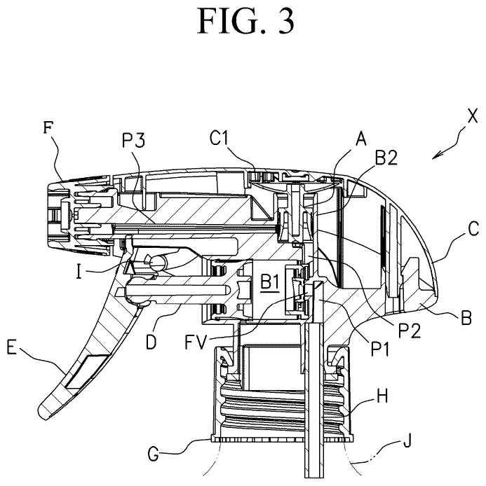

FIG. 3 is a longitudinal sectional view showing the accumulator sprayer X of the present invention.

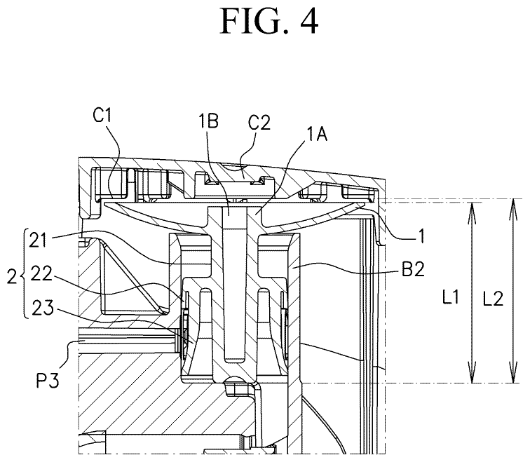

FIG. 4 is a longitudinal sectional view showing an arrangement state of a second valve structure A in the accumulator sprayer X of the present invention, illustrating an unloaded state in an initial set state.

The accumulator sprayer X has a function that allows a piston portion to be moved backwards by rotating a trigger portion E, applying pressure to liquid in a cylinder, and then spraying the liquid outwards from a nozzle portion F with great force when the pressure exceeds a certain level, and the second valve structure A plays a role in accumulating that pressure.

As for the structure, the accumulator sprayer X of the present invention includes the nozzle portion F, a base portion B, the piston portion D, a cover portion C, the trigger portion E, the second valve structure A, a first valve FV, an introduction tube H, a trigger-returning spring I, a cap portion G, and a packing K.

The base portion B includes a main cylinder portion B1, a sub-cylinder portion B2, a first passage portion P1, a second passage portion P2, and third passage portion P3, etc., and is an important portion that has a passage through which liquid flows.

The accumulator sprayer X of the present invention is formed of the above-described 11 parts.

In this regard, the flow of the liquid is as follows: container J→introduction tube H→first passage portion P1→first valve FV→main cylinder portion B1→second passage portion P2→sub-cylinder portion B2→second valve structure A→third passage portion P3→nozzle portion F→outside.

Moreover, since the materials of each part are made of PO (polyolefin), they can be recycled. Here, it is preferable to use PP (polypropylene) as the material for the nozzle portion F, the trigger portion E, the trigger-returning spring I, the base portion B, the second valve structure A, the cover portion C, the cap portion G, and the introduction tube H.

In addition, it is preferable to use LLDPE (linear low-density polyethylene) for the piston portion D and the first valve FV, and it is preferable to use EPE (expanded polyethylene) for the packing K.

By specifying the materials as above, it has been possible to keep the total weight of the accumulator sprayer X, which does not use metal parts, to 20 g or less.

In this regard, the weight relationship between the parts is, for example, as follows: 1) base portion B>2) cover portion C>3) cap portion G>4) trigger portion E>5) introduction tube H>6) trigger-returning spring I>7) nozzle portion F>8) piston portion D>9) second valve structure A>10) first valve FV>11) packing K. Next, the mutual arrangement of the parts will be described.

First, the nozzle portion is attached to the tip of the base portion B, and the liquid is sprayed outwards from here.

The base portion B is an important part that has passages where the liquid flows through, and becomes the foundation.

As described above, this base portion B includes the main cylinder portion B1, the sub-cylinder portion B2, the first passage portion P1, the second passage portion P2, and the third passage portion P3.

For more details, the base portion B includes the main cylinder portion B1 that accepts the piston portion D below, and the sub-cylinder portion B2 that accepts the second valve structure A above.

The base portion B, as described above, includes the first passage portion P1 that introduces the liquid in the container into the main cylinder portion B1, the second passage portion P2 that introduces the liquid from the main cylinder portion B1 into the sub-cylinder portion B2 where the second valve structure A is located, and the third passage portion P3 that introduces the liquid from the sub-cylinder portion B2 into the nozzle portion F.

In addition, the piston portion D reciprocates and slides within the main cylinder portion to apply pressure or negative pressure to the liquid.

A support shaft portion BA is formed protrusively on a side surface of the base portion B and the trigger portion E pivots around this support shaft portion BA as a fulcrum to slide the piston portion D rearward.

To apply pressure to the inside of the cylinder, rotate the trigger portion E backwards and slide the piston portion D backwards.

Conversely, to depressurize the inside of the cylinder, the trigger portion E rotates forward by itself due to the trigger-returning spring I, and the piston portion D slides forward (returning motion).

On the other hand, the first passage portion P1 is provided with the first valve FV.

For details, the first valve FV is provided in the first passage portion P1 between the main cylinder portion B1 and the container J.

In addition, the second valve structure A (described in detail later) is attached to the sub-cylinder portion B2.

For details, the second valve structure A is provided between the main cylinder portion B1 and the inlet of the passage (i.e. the third passage portion P3) that sends the liquid to the nozzle portion F.

The introduction tube H forms a passage that sucks up the liquid in the container and passes it to the direction of the main cylinder portion B1.

A flange portion is provided at a lower end of the base portion B, and by screwing on the cap portion G, the flange portion is pressed against a container opening to attach and fix the base portion B.

Note that the packing K is used to seal the gap between the flange portion and the upper end of the opening.

On the other hand, the cover portion C is attached to the base portion B to cover it from above.

Meanwhile, as described above, the base portion B has a sub-cylinder portion B2 in its upper side, and the inner circumferential wall of the sub-cylinder portion B2 forms a space on the downstream side of the second passage portion P2.

The second valve structure A is attached to the space in this inner circumferential wall.

Here, the cover portion C covers the base portion B, but as described above, a part of an inner side of the cover portion C serves as a support wall portion C1 where a spring portion 1 of the second valve structure A abuts.

Also, a stopper portion C2 is formed inside the support wall portion C1, but this point will be described later.

When the liquid is sprayed from the nozzle portion, the second valve structure a moves upwards, and the circumferential edge of the reverse-dome-shaped spring portion 1 is pressed against this support wall portion C1, causing the valve to open.

Conversely, the spring portion 1 presses the valve piston portion 2 downward, causing the second valve structure A to move downward and close the valve.

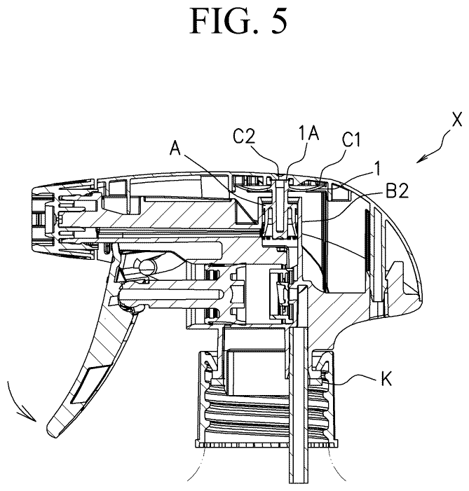

Next, the second valve structure A is discussed in detail below. FIG. 5 is a longitudinal sectional view showing the accumulator sprayer X of the present invention, illustrating a state where the second valve structure A has reached a top dead center.

The second valve structure A is formed of the spring portion 1 and a skirt-shaped valve piston portion 2 drooping from the spring portion 1.

The spring portion 1 is formed in an inverted dome shape (in other words, a dish shape) so as to be able to exert a spring-back effect as the second valve structure A.

On the other hand, the valve piston portion 2 includes a core rod portion 21 and skirt portions extending downward from the outer circumference of the core rod portion 21. The number of skirt portions is two, and the skirt portions are formed of an outer skirt portion 22 and an inner skirt portion 23 extending long downward from the outer skirt portion 22.

Here, although will be described further below, the outer skirt portion 22 plays a role of sealing, and also the inner skirt portion 23 plays a role of a valve body.

The core rod portion 21 is formed as a cylinder shape between the spring portion 1 and the outer skirt portion 22.

When the second valve structure A moves up and down, even if there is some axial misalignment, there is no contact with the wall surface of the sub-cylinder portion B2, and thus no hindrance to the movement.

The core rod portion 21 of the valve piston portion 2 is formed to have a hollow, and its hollow hole portion 1B is open at the center of the inverted-dome-shaped spring portion 1.

In this manner, with the hollow hole portion 1B provided in the core rod portion 21, therefore the valve piston portion 2 becomes more difficult to bend, so the valve function can be more appropriately exerted.

The upper end of the core rod portion 21 protrudes from the inverted-dome-shaped spring portion 1 to form a tubular protrusion 1A.

This tubular protrusion 1A comes into contact with the stopper portion C2, which is provided on the cover portion C, when the second valve structure A moves upward and reaches its top dead center.

Therefore, the upward movement of the second valve structure A is restricted, and as a result, the deformation of the spring portion 1 is suppressed within a certain range.

Incidentally, without the tubular protrusion 1A and the stopper portion C2, the inverted-dome-shaped spring portion 1 may completely flip inside out or undergo extreme distorted deformation.

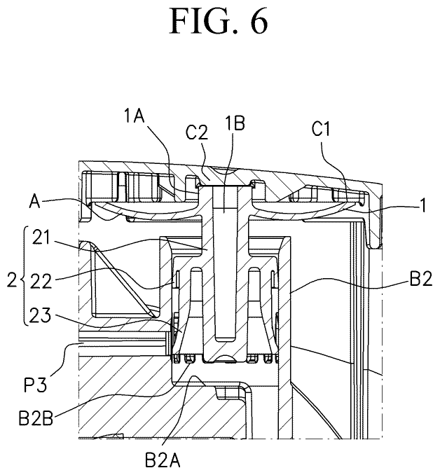

In the state shown in FIG. 6, the liquid flows into the third passage portion via a vertical groove portion B2B provided in the sub-cylinder portion.

Here, in the incorporated state (initial set state), it is preferable that the second valve structure A is either in contact with the support wall portion C1 of the cover portion C or the bottom B2A of the sub-cylinder portion B2, or in a state where it is not in contact with either.

The reason is that, if a compressive load is applied to the second valve structure A in the vertical direction during the initial set state, the spring portion remains constantly under pressure, which makes it more prone to so-called plastic deformation of the material (polyolefin resin).

Therefore, as the usage period extends, the spring force of the second valve structure A decreases.

In the initial set state, when the second valve structure A is in contact with both the support wall portion C1 of the cover portion C and the bottom B2A of the sub-cylinder portion B2, the second valve structure A is subjected to a compressive force in the vertical direction.

Let the distance between the bottom B2A of the sub-cylinder portion B2 and the support wall portion C1 of the cover portion C be denoted as L2, and let the vertical length of the second valve structure A in an unloaded state be denoted as L1, it is preferable that the relationship between them becomes L2>L1 (see FIG. 4).

Incidentally, in the state where the second valve structure A is not incorporated, its length is the same as L1, which is the vertical length in an unloaded state.

Incidentally, in the conventional art, when the second valve structure A is incorporated into the accumulator sprayer (initial set state), the upper end portion is supported by the support wall portion C1 of the cover portion C, while the lower end portion is supported by the bottom of the sub-cylinder portion B2.

As a result, the second valve structure A is always in a state where pressure is applied in the vertical direction, that is, in a state where a load is applied in the direction of compression.

In the foregoing, the characteristics of the structure of the accumulator sprayer X and the second valve structure A of the present invention have been described, however, the accumulator sprayer X has several additional features, which are described below.

### Special Feature of the Cross-Section of the Support Shaft Portion BA

As described above, the support shaft portion BA is formed protrusively on a side surface of the base portion B, and the trigger portion E can pivot around the support shaft portion BA as a fulcrum.

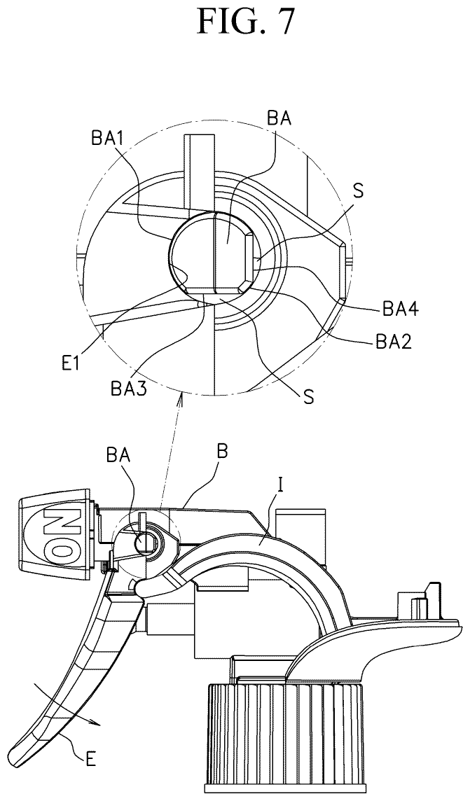

FIG. 7 is a diagram illustrating the relationship between the trigger portion and the support shaft portion.

Note that the portion enclosed by the dashed line is shown in an enlarged view.

In the present invention, as can be seen from the FIG., the cross-sectional shape of the support shaft portion BA has a large arc portion BA1 and a small arc portion BA2, with a defected portion between them, forming a first chord portion BA3 and a second chord portion BA4.

As a result, a small space S is created between the bearing hole portion E1 of the trigger portion E and the support shaft portion BA, leading to a reduction in friction and resulting in improved energy efficiency compared to the conventional art.

Particularly, as shown in the FIG., when the small space S is formed at the rear side, it requires less effort and is effective when pulling the trigger portion E to rotate it.

Incidentally, in the conventional art, the cross-sectional shape of the support shaft portion BA is a true circle.

### Reduction of the Pulling Force and Increasing the Ejection Volume

Since the accumulator sprayer X of the present invention incorporates the second valve structure A having both spring function and valve function, both the spring function and the valve function can be exhibited in a smaller spatial region.

Therefore, the second valve structure A can be positioned as far upward as possible, thereby the available installation area of the main cylinder portion B1 toward the rear side can be extended.

As a result, the rearward travel distance of the piston portion D can be increased, allowing for a larger discharge volume.

Furthermore, by reducing the cylinder diameter, the mechanical load (that is, the pulling force) required to pull the trigger portion E has also been minimized.

Here, in the present invention, the cylinder diameter can be in the range of 12.5 mm to 14 mm, and the movement distance (stroke) of the piston portion D can be in the range of 8.5 mm to 10 mm.

Among these, from the perspectives of the mechanical load required to pull the trigger portion E and the discharge volume, it is particularly preferable for the cylinder diameter to be 13.5 mm and the movement distance of the piston portion D to be 9 mm, in which case the discharge volume of the liquid is 1.3 cc.

Incidentally, in the conventional art, the cylinder diameter is in the range of 14.5 mm to 15.2 mm, and the movement distance of the piston portion D is usually in the range of 6 mm to 7 mm.

Particularly, a cylinder diameter of 14 mm with a piston portion D movement distance of 7 mm was commonly used, and in such cases, the discharge volume of the liquid was 1.08 cc.

Furthermore, the above-described points have been demonstrated by the applicant using the accumulator sprayer X of the present invention, which is the same size as the accumulator sprayer X of the prior art (PTL 1).

### Reduction in the Number of Parts During Manufacturing

The trigger portion E and the trigger-returning spring I are formed integrally by injection molding during manufacturing.

Although they become separate components after assembly, they can be manufactured simultaneously as a single unit, manufacturing costs can be significantly reduced.

In the foregoing, while a preferred embodiment of the present invention has been described, the present invention is not meant to be limited to the above-described embodiment.

In the accumulator sprayer X of the present invention, the material of the parts is polyolefin, and any suitable material within the range of polyolefin can be appropriately used.

Additionally, for the first valve FV, any valve that has the function of allowing the liquid to escape in one direction can be used.

Furthermore, exterior shapes different from that shown in FIG. 1 are, of course, within the scope of design modifications.

### Industrial Applicability

The accumulator sprayer X of the present invention is formed with parts, all of them are made of polyolefin, and the number of parts is kept to a minimum, making recycling easy, thereby contributing to resource efficiency and ultimately to the achievement of SDGs, and this is quite useful.

### REFERENCE SIGNS LIST

X . . . accumulator sprayer
A . . . second valve structure
1 . . . spring portion
1A . . . tubular protrusion
1B . . . hollow hole portion
2 . . . valve piston portion
21 . . . core rod portion
22 . . . outer skirt portion
23 . . . inner skirt portion
B . . . base portion
BA . . . support shaft portion
BA1 . . . large arc portion
BA2 . . . small arc portion
BA3 . . . first chord portion
BA4 . . . second chord portion
B1 . . . main cylinder portion
B2 . . . sub-cylinder portion
B2A . . . bottom of the sub-cylinder portion
B2B . . . vertical groove portion of the sub-cylinder portion
C . . . cover portion
C1 . . . support wall portion
C2 . . . stopper portion
D . . . piston portion
E . . . trigger portion
E1 . . . bearing hole portion
F . . . nozzle portion
G . . . cap portion
H . . . introduction tube
I . . . trigger-returning spring
J . . . container
K . . . packing
FV . . . first valve
P1 . . . first passage portion
P2 . . . second passage portion
P3 . . . third passage portion
S . . . small space

1. An accumulator sprayer comprising parts made of polyolefin material, wherein the parts include: a nozzle portion; a base portion containing a first passage portion having a sub-cylinder portion located above and a main cylinder portion located below, and connecting a container to the main cylinder portion, a second passage portion connecting the main cylinder portion to the sub-cylinder portion, and a third passage portion connecting the sub-cylinder portion to the nozzle portion; a piston portion that slides within the main cylinder portion; a trigger portion that pivots around a support shaft portion, formed protrusively on a side surface of the base portion, as a fulcrum and slides the piston portion rearward; a trigger-returning spring that returns the trigger portion forward; a first valve provided in the first passage portion; a second valve structure mounted in the sub-cylinder portion; an introduction tube that suctions up and passes through the liquid from the container; a cover portion that covers the base portion from above; a cap portion for attaching to the container; and a packing for sealing the cap portion and the base portion.

2. The accumulator sprayer according to claim 1, wherein the second valve structure comprises a spring portion and a valve piston portion, and the spring portion and the valve piston portion are integrally molded.

3. The accumulator sprayer according to claim 1, wherein the second valve structure is in an unloaded state, not subjected to compressive force in a vertical direction, in an initial set state when incorporated into the accumulator sprayer.

4. The accumulator sprayer according to claim 1, wherein a support shaft portion formed on the base portion has a cross-sectional shape including a large arc portion and a small arc portion, with a defect portion formed between them.

5. The accumulator sprayer according to claim 3, wherein let a distance between a bottom of the sub-cylinder portion and a support wall portion of the cover portion be denoted as L2, and let a vertical length of the second valve structure in an unloaded state be denoted as L1, the relationship between them becomes L2>L1.

6. The accumulator sprayer according to claim 1, wherein the trigger portion and the trigger-returning spring are formed integrally by injection molding during manufacturing.
